(19) United States
(12) Patent Application Publication
(10) Pub. No.: US 2011/0204041 A1
(43) Pub. Date: Aug. 25, 2011

(54) ELECTRIC HEATING ELEMENT WITH A CONNECTION ELEMENT AND PROCESS FOR MANUFACTURING AN ELECTRIC HEATING ELEMENT WITH A CONNECTION ELEMENT

(76) Inventor: Andreas SCHLIPF, Tuttlingen (DE)

(21) Appl. No.: 13/033,097

(22) Filed: Feb. 23, 2011

(30) Foreign Application Priority Data
Feb. 24, 2010 (DE) 10 2010 009 180.4

(51) Int. Cl. H05B 3/02; H01C 17/02

(52) U.S. Cl. 219/546; 29/611

(57) ABSTRACT

An electrical heating element with a metal jacket, a connecting element lying against the metal jacket at least in some sections and at least one electrical connection. The connecting element has at least one cavity, which borders on a section of the metal jacket at least in some sections and/or on a section of the electrical connection, and the cavity is cast at least partly with a pourable sealing compound, especially with a ceramic cement, epoxy resin or plastic, such that a direct, supporting mechanical connection is consequently produced between the metal jacket and the connecting element and/or between the section of the electrical connection and the connecting element by the pourable sealing compound, wherein the pourable sealing compound is also in contact with an element for securing against rotation, and a process for the manufacture of such an electrical heating element.

### CROSS REFERENCE TO RELATED APPLICATIONS

This application claims the benefit of priority under 35 U.S.C. §119 of German Patent Application DE 10 2010 009 180.4 filed Feb. 24, 2010, the entire contents of which are incorporated herein by reference.

### FIELD OF THE INVENTION

The present invention pertains to an electrical heating element and a process for manufacturing such an electrical heating element. Such heating elements are used for heating tools, machine parts and devices or media used in same.

### BACKGROUND OF THE INVENTION

Basically, in all these applications, the question arises as to how the respective electrical heating element used can be fastened to the respective device. A connecting element, for example, a flange, threaded nipple, angle, fitting, a disk or another suitable turned, punched or cast part, is usually provided for this.

At the same time, this connecting element is usually the point, at which a force and/or a torque are exerted, when a heating element which was already used shall be removed, for example, when replacing the heating element. It has been shown in practice that, after long use, heating elements often sit very rigidly in their mount because of deposits on the heating element, so that they have to be loosened or detached before the actual removal by applying a considerable torque to the connecting element. This results in the need to prepare a connection between connecting element and heating element, which is not twisted against its original position even when a considerable torque is applied, since, with insufficient torsional strength, the heating element can no longer be loosened in its mount and thus can no longer be removed from there.

The connecting element is therefore usually pressed, welded or soldered on in order to be able to withstand such stresses. These work steps lead to considerable costs in the manufacture of the electrical heating element.

As an alternative, it is known, e.g., from DE 203 08 941 U1 to inject prepared plastic parts on the heating element by injection molding, which can then be used as a connection element. However, because of the high tool costs associated therewith, this is also an expensive process, which may be profitable for mass production at the most.

Furthermore, it is unfavorable in all these processes that in such attached connecting elements, a considerable thermal or mechanical stress is always exerted on the heating element, with which routinely undesired damage is brought about to installed sensors, securing elements and switches as well as to stranded wire insulation and/or pourable sealing compound and thus the reject rate is increased. Further, an impairment to a possible surface treatment of the heating element, e.g., due to tempering colors and/or other thermal or mechanical damage, as it is experienced, for example, by an electropolished surface in the above-mentioned methods, routinely occurs in this manner of attaching the connecting element to the heating element.

### SUMMARY OF THE INVENTION

Therefore, the object of the present invention is to provide an electrical heating element with a connecting element arranged on it, which can be manufactured in an especially favorable manner and especially cost-effectively and whose connecting element is connected in such a way to the electrical connecting element that a good securing against rotation is achieved. In addition, damage to the heating element by means of mechanical and thermal stress or a possible structural change in the connecting element during welding shall be largely avoided.

This object is accomplished by an electrical heating element of the present invention and a process for manufacturing such an electrical heating element of the present invention.

The electrical heating element according to the present invention has a metal jacket, a connecting element lying on the metal jacket at least in some sections and at least one electrical connection. According to the present invention, the connecting element has at least one cavity, which borders, at least in some sections, on one section of the metal jacket, for example its front side, and/or on a section of the electrical connection. Furthermore, the cavity is cast at least partly with a pourable sealing compound, especially with a ceramic cement, epoxy resin or plastic, such that a direct, supporting mechanical connection is consequently produced between the metal jacket and the connecting element and/or between the section of the electrical connection and the connecting element by the pourable sealing compound.

Thus, the pourable sealing compound is used here not only as a means for securing a differently produced mechanical connection between connecting element and electrical heating element, and especially with regard to sealing and electrical insulation, but also represents this mechanical connection directly. This permits a very cost-effective manufacture.

Not absolutely the shortest connection is intended with the term “direct connection” in this regard. A direct connection in terms of this patent application is present if there is a path between metal jacket and connecting element or section of the electrical connection and connecting element that leads completely through pourable sealing compound.

Furthermore, it is made explicitly clear that the connecting element may be multisectional, e.g., when a ring or spacer is pushed onto the heating element, then the part of the connecting element, which makes possible the fastening, e.g., by means of its thread, is pushed onto this, and then is cast with pourable sealing compound.

The thermal stress during casting with pourable sealing compound is markedly less than the stress occurring during welding, soldering or injection molding; a mechanical stress as when pressing on the connecting element does not develop. Therefore, the manner of connection according to the present invention is especially suitable for avoiding damage to installed sensors, securing elements and switches as well as to stranded wire insulation and/or pourable sealing compound. At the same time, it is a cost-effective solution, especially also since the operation of welding, soldering or pressing is entirely omitted.

To guarantee that the connection using the pourable sealing compound has the needed securing against rotation, a means for securing against rotation is, moreover, provided according to the present invention, with which the pourable sealing compound is in contact.

The electrical heating element may be, for example, a heating cartridge, a tubular heating body, or a screw-in heating body.

The connecting element lying on the metal jacket in at least some sections may be, for example, a flange, a threaded nipple, an angle, a fitting, a disk or another suitable turned, punched or cast part.

On an end-side section of the metal jacket within the metal jacket, the heating device according to the present invention has at least one cavity, which passes over into at least one cavity of the connecting element. A cavity is also basically defined here as an opening passing through the connecting element.

The core idea of the present invention is that these cavities are cast at least partly with a pourable sealing compound, for example, with epoxy resin or a plastic, and a compact connection is consequently produced between the metal jacket and the connecting element, wherein the needed torsional strength is guaranteed by the provision of a means for securing against rotation.

In a preferred embodiment of the present invention, the means for securing against rotation is embodied at least partly as a structuring of a section of the metal jacket that is not rotationally symmetrical to the central axis of the heating element. On a section of the metal jacket, which is in contact with the pourable sealing compound, a recess or elevation or projection is then arranged, which prevents a simple “full rotation” of the metal jacket in relation to the pourable sealing compound. As an alternative, the same effect can be achieved or the effect can be additionally reinforced when the end section of the metal jacket, which is in contact with the pourable sealing compound, is deformed such that it no longer has rotational symmetry.

As an alternative or in addition, the means for securing against rotation can be embodied at least partly as a structuring of a section of the connecting element that is not rotationally symmetrical to the central axis of the heating element, when the connecting element is positioned on the heating element. On a section of the connecting element, which is in contact with the pourable sealing compound, a recess or elevation or projection is then arranged, which prevents a simple “full rotation” of the connecting element in relation to the pourable sealing compound. As an alternative, the same effect can be achieved or the effect can be additionally reinforced when the section of the connecting element, which is in contact with the pourable sealing compound, is deformed such that it no longer has rotational symmetry.

Especially in electrical heating elements, which are operated with high currents and therefore have relatively thick and stiff electrical connections, the means for securing against rotation may also be embodied at least partly as an arrangement of the at least one electrical connection that is not rotationally symmetrical to the central axis of the heating element. This embodiment is especially inexpensive in the manufacture, since it does not need any additional processing steps for the metal jacket and/or connecting element.

As is explained by the phrase “at least partly” in the description of the above three embodiments, these measures may also be combined to guarantee an especially good means for securing against rotation.

Especially preferred in this connection are means for securing against rotation, in which at least one structuring of a section of the connecting element meshes with at least one structuring of a section of the metal jacket or embraces same.

One possibility of achieving an especially high mechanical stability of the connection is given when the cavity has a partial area, which is defined by an outer jacket surface of the metal jacket.

An alternative or additional possibility for increasing the mechanical stability is that the electrical heating element has, on an end-side section of the metal jacket within the metal jacket, at least one cavity, which passes into the at least one cavity of the connecting element, and that these cavities are at least partly cast with the pourable sealing compound.

For clarification, it is pointed out that the phrase “within the metal jacket” only means that the heating element or heating elements passes/pass through a space, for which the metal jacket forms a jacket surface.

The electrical heating element is especially cost-effective when the connecting element is made of plastic. In the conventional manner of fastening by means of welding, soldering or pressing, the use of this material is not possible or the strength of the connection achieved is unsatisfactory. In the injection molding of the connection element made of plastic, a corresponding contact has to be present with the necessary forms for any desired connecting element at the manufacturer, while in the heating element embodied according to the present invention for using connecting elements made of plastic, only the connecting elements have to be prepared, e.g., by a supplier.

Especially firm connections between the connecting element and electrical heating element can be achieved when the connecting element and/or metal jacket have a contour shape, especially an undercut, a notch, a bulging out, a knurling, a hole, or a score on its end section having the cavity.

Connecting elements that have an external thread or mounting holes can be used especially well. In this case, the heating element can be fastened by means of a simple screwing in at a counterthread at the device, which shall achieve the heating function, or by passing holding elements, e.g., screws or pins through the mounting holes.

An electrical heating element especially well protected against the penetration of moisture is obtained when the electrical connection of the electrical heating element has a contact element on the end side, which is in electrical connection with a supply line, and when the contact element and at least the section of the supply line incorporated into the contact element are embedded into the pourable sealing compound.

The process according to the present invention for manufacturing an electrical heating element with a metal jacket, a connecting element lying on the metal jacket on at least some sections and at least one electrical connection has at least the following steps: preparing an electrical heating element with a metal jacket and at least one electrical connection, preparing a connecting element that can be arranged on at least one section of the metal jacket, which has at least one section, with which it lies on the metal jacket in the state arranged on the metal jacket and which has at least one cavity;

arranging the connecting element on a section of the metal jacket, wherein the arranging takes place in such a way that the at least one cavity borders on a section of the metal jacket, e.g., its front side, and/or on a section of the electrical connection at least on some sections; and
at least partial casting of the cavity with a pourable sealing compound, especially with a ceramic cement, an epoxy resin or plastic, such that a direct, supporting mechanical connection between the metal jacket and the connecting element and/or between the section of the electrical connection and the connecting element is produced, such that the pourable sealing compound is in contact with a means for securing against rotation provided at the prepared heating element and/or at the prepared connecting element.

As mentioned above, this manufacturing process is markedly more cost-effective than prior-art alternatives. Furthermore, the thermal stress during casting with a pourable sealing compound is markedly less than the stress occurring during welding, soldering or injection molding; a mechanical stress as when pressing on the connecting element does not develop. Therefore, the manner of connection according to the present invention is especially suitable for avoiding damage to installed sensors, securing elements and switches, as well as to stranded wire insulation and/or pourable sealing compound. At the same time, it is a cost-effective solution, especially also since the operation of welding, soldering or pressing is entirely omitted.

To prepare the means for securing against rotation, a structuring of a section of the metal jacket that is not rotationally symmetrical to the central axis of the heating element can be embodied before or after preparation of the heating element but before casting and/or a structuring of a section of the connecting element that is not rotationally symmetrical to the central axis of the heating element can be embodied before or after preparation of the connecting element but before casting and/or an electrical heating element is prepared, which has an arrangement of the at least one electrical connection that is not rotationally symmetrical to the central axis of the heating element.

As is explained by the phrase “at least partly” in the description of the above three embodiments, these measures may also be combined to guarantee an especially good means for securing against rotation.

An embodiment of the process that leads to more stable connections provides that the connecting element is arranged on the section of the metal jacket, such that the cavity has a partial area, which is defined by an outer jacket surface of the metal jacket.

The stability of the connection can be even further increased when at least one cavity is provided in the electrical heating element with metal jacket on an end-side section of the metal jacket within the metal jacket, that the connecting element is arranged such that the cavity passes over into the at least one cavity of the connecting element, and that the at least partial casting takes place such that both cavities are at least partly cast with a pourable sealing compound.

The process is especially cost-effective if a connection between the metal jacket and a connecting element made of plastic is produced by the casting.

Especially firm and stable connections are achieved when a contour shape, especially an undercut, a notch, a bulging out, a knurling, or a score is provided in the connecting element and/or in the metal jacket at its end section having the cavity.

It is especially advantageous when the contour shape is provided after arranging the connecting element on the metal jacket of the heating element and before casting with epoxy resin or plastic, since this makes possible the use of contour shapes, which prevent the later arrangement of the connecting element. This is, e.g., the case when the arranging shall take place by pushing on the connecting element and an expansion of the metal jacket is provided in some sections.

Electrical heating elements especially well protected against the penetration of moisture are obtained, when a contact element, which has an electrical connection on an end side, is brought into electrical connection with a supply line before casting, and when the contact element and at least the section of the supply line incorporated into the contact element are embedded into the pourable sealing compound during the casting.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1a is a view of the end area of a first exemplary embodiment of the present invention, wherein the end-side section of the end area is shown cut open;

FIG. 1b is a front view of the connecting element of the exemplary embodiment of FIG. 1a;

FIG. 2a is a view of the end area of a second exemplary embodiment of the present invention, wherein the end-side section of the end area is shown cut open;

FIG. 2b is a front view of the connecting element of the exemplary embodiment from FIG. 2a;

FIG. 3a is a view of the end area of a third exemplary embodiment of the present invention, wherein the end-side section of the end area is shown cut open;

FIG. 3b is a front view of the connecting element of the exemplary embodiment of FIG. 3a;

FIG. 4a is a view of the end area of a fourth exemplary embodiment of the present invention, wherein the end-side section of the end area is shown cut open;

FIG. 4b is a front view of the connecting element of the exemplary embodiment of FIG. 4a;

FIG. 5a is a view of the end area of a fifth exemplary embodiment of the present invention, wherein the end-side section of the end area is shown cut open;

FIG. 5b is a front view of the connecting element of the exemplary embodiment of FIG. 5a;

FIG. 6a is a view of the end area of a sixth exemplary embodiment of the present invention, wherein the end-side section of the end area is shown cut open;

FIG. 6b is a front view of the connecting element of the exemplary embodiment of FIG. 6a;

FIG. 7a is a view of the end area of a seventh exemplary embodiment of the present invention, wherein the end-side section of the end area is shown cut open;

FIG. 7b is a view of a cutout enlargement of FIG. 7a;

FIG. 8a is a view of the end area of a eighth exemplary embodiment of the present invention, wherein the end-side section of the end area is shown cut open;

FIG. 8b is a front view of the connecting element of the exemplary embodiment of FIG. 8a;

FIG. 9a is a view of the end area of a ninth exemplary embodiment of the present invention, wherein the end-side section of the end area is shown cut open;

FIG. 9b is a front view of the connecting element of the exemplary embodiment of FIG. 9a;

FIG. 10a is a view of the end area of a tenth exemplary embodiment of the present invention, wherein the end-side section of the end area is shown cut open;

FIG. 10b is a front view of the connecting element of the exemplary embodiment of FIG. 10a;

FIG. 11a is a view of the end area of a eleventh exemplary embodiment of the present invention, wherein the end-side section of the end area is shown cut open; and

FIG. 11b is a front view of the connecting element of the exemplary embodiment of FIG. 11a.

### DESCRIPTION OF THE PREFERRED EMBODIMENTS

In all figures identical reference numbers are used for identical components of identical exemplary embodiments.

Referring to the drawings in particular, FIG. 1a shows a view of the end area A of a first exemplary embodiment of an electrical heating element 10 according to the present invention, wherein the end-side section B of the end area of the electrical heating element 10 is shown cut open. A section (not shown) of the electrical heating element 10 continues this to the right in the view shown, it may have any shape, and be especially straight, bent, coiled or meandering. One recognizes a metal jacket 11 and electrical connections 13 and 14, which form the electrical connection to a hot wire, hot coil or resistance wire arranged in the interior of the heating element. The metal jacket 11 is usually embodied as tubular, it may have a circular cross section, especially as shown here, but also a different, e.g., oval or polygonal, especially triangular, rectangular or square cross section. The electrical connections 13 and 14, but at least the hot wires connected thereto, are embedded within the metal jacket 11 in a medium at least in some sections. It is typically MgO, but other materials are also conceivable. The hot wires may also be wound up on a carrier or pressed into same, wherein the carrier for its part may then be in turn optionally embedded in a medium or be part of a layered structure.

At the end section of the metal jacket 11 is arranged a notch 12, i.e., a narrow section of the edge area is bent inwards, while the adjacent section in the radial direction is not bent. Furthermore, it has on the end side a cavity 19, which is not filled with the medium 15.

Further, a connecting element 16 is shown, which lies on the metal jacket 11 with a section 17 and has a cavity 19′, which passes over into the cavity 19. The electrical connections 13 and 14 are passed through this cavity. A separating line between the cavities 19 and 19′ is shown dashed in FIG. 1a for illustration. Aside from the volume occupied by the passed-through connections 13, 14, the cavities 19 and 19′ are completely cast with pourable sealing compound 18, as a result of which a rigid, especially firm connection is brought about between the connecting element 16 and the metal jacket 11.

Further, the cavity 19′ has a partial area 19″, which is defined by an outer jacket surface of the metal jacket 11 and is likewise cast with pourable sealing compound 18. This enlarges the surface, on which a contact is present between pourable sealing compound 18 and metal jacket 11, which brings with it a stronger mechanical hold.

The means for securing against rotation is embodied in this exemplary embodiment by means of the combination of two independent measures: On the one hand, the electrical connections 13, 14 are arranged not rotationally symmetrical to the central axis of the heating element 10 shown in FIGS. 1a through 8a as broken line with consecutive long and short segments. This measure, which is also present in all other exemplary embodiments, but is not absolutely necessary, already results in that a full rotation of the pourable sealing compound 18 in relation to the metal jacket 11 is prevented, because, for this, either the electrical connections 13, 14 would have to be deformed or separated, or pourable sealing compound 18 would have to be split by the electrical connections 13, 14. Thus, increased torsional strength is achieved.

On the other hand, with the notch 12, a structuring of a section of the metal jacket 11 that is not rotationally symmetrical to the central axis of the heating element 10 is present, which likewise permits a full rotation of the pourable sealing compound 18 in relation to the metal jacket only by deforming or separating the notch 12 or splitting the pourable sealing compound 18 and thus leads to increased torsional strength.

FIG. 1b shows a front view of the connecting element 16 of the exemplary embodiment of FIG. 1a. One recognizes the pourable sealing compound 18 as well as the connections 13, 14 passed through it.

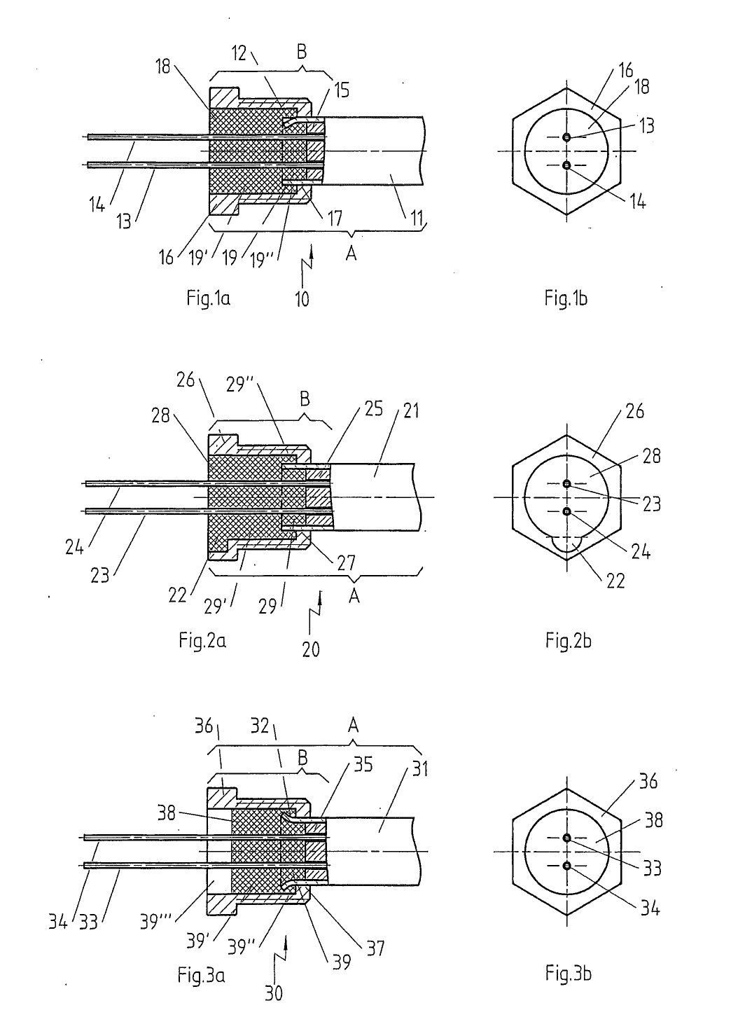

FIG. 2a shows a view of the end area A of a second exemplary embodiment of an electrical heating element 20 according to the present invention, wherein the end-side section B of the end area A of the electrical heating element 20 is shown cut open. A section (not shown) of the electrical heating element 20 continues this to the right as in the view shown in FIG. 1a.

One recognizes a metal jacket 21 and electrical connections 23 and 24. The metal jacket 21 is usually embodied as in the above-described first exemplary embodiment. The connections 23 and 24 are embedded within the metal jacket 21 in a medium 25 at least in some sections, possible details of this embedding were already described based on the first exemplary embodiment.

The end section of the metal jacket 21 has on the end side a cavity 29, which is not filled with the medium 25.

Further, a connecting element 26 is shown, which lies on the metal jacket 21 with a section 27 and has a cavity 29′, which passes over into the cavity 29. The electrical connections 23 and 24 are passed through this cavity. A separating line between the cavities 29 and 29′ is shown dashed in FIG. 2a for illustration. Aside from the volume occupied by the passed-through connections 23, 24, the cavities 29 and 29′ are completely cast with pourable sealing compound 28, as a result of which a rigid, especially firm connection between the connecting element 26 and the metal jacket 21 is brought about. Further, the cavity has a bulge 22, which can be used as an orientation aid or matching structure, when the electrical heating element has to be arranged in a preset orientation.

With the bulge 22, a structuring of a section of the connecting element 26 that is not rotationally symmetrical to the central axis of the heating element 20 is also present, which interacts with the pourable sealing compound 28. Thus, a full rotation of the pourable sealing compound 28 in relation to the connecting element 26 is made possible only by deforming the bulge 22 or splitting the pourable sealing compound 28 and thus brings about increased torsional strength.

Further, the cavity 29′ has a partial area 29″, which is defined by an outer jacket surface of the metal jacket 21 and is likewise cast with pourable sealing compound 28. This enlarges the surface, on which a contact is present between pourable sealing compound 28 and metal jacket 21, which brings with it a stronger mechanical hold.

FIG. 2b shows a front view of the connecting element 26 of the exemplary embodiment of FIG. 2a. One recognizes the pourable sealing compound 28 as well as the connections 23, 24 passed through it besides the symmetry-breaking bulge 22.

FIG. 3a shows a view of the end area A of a third exemplary embodiment of an electrical heating element 30 according to the present invention, wherein the end-side section B of the end area A of the electrical heating element 30 is shown cut open. A section (not shown) of the electrical heating element 30 continues this to the right as in the view shown in FIG. 1a.

One recognizes a metal jacket 31 and electrical connections 33 and 34. The metal jacket 31 is usually embodied as in the above-described first exemplary embodiment. The electrical connections 33 and 34 are embedded within the metal jacket 31 in a medium 35 at least in some sections, possible details of this embedding were already described based on the first exemplary embodiment.

The end section of the metal jacket 31, which shows a circumferential bulging out 32 at its end, has on the end side a cavity 39, which is not filled with the medium 35.

Further, a connecting element 36 is shown, which lies on the metal jacket 31 with a section 37 and has cavities 39′ and 39′″, wherein the cavity 39′ passes over into the cavity 39. The connections 33 and 34 are passed through this cavity. A separating line between the cavities 39 and 39′ is shown dashed in FIG. 3a for illustration. Aside from the volume occupied by the passed-through connections 33, 34, the cavities 39 and 39′ are cast with pourable sealing compound 38, as a result of which a rigid, especially firm connection between the connecting element 36 and metal jacket 31 is brought about. The cavity 39′″ is not cast.

Further, the cavity 39′ has a partial area 39″, which is defined by an outer jacket surface of the metal jacket 31 and is likewise cast with pourable sealing compound 38. This enlarges the surface, on which a contact between pourable sealing compound 38 and metal jacket 31 is present, which brings with it a stronger mechanical hold.

FIG. 3b shows a front view of the connecting element 36 of the exemplary embodiment of FIG. 3a. One recognizes the pourable sealing compound 38 as well as the connections 33, 34 passed through it.

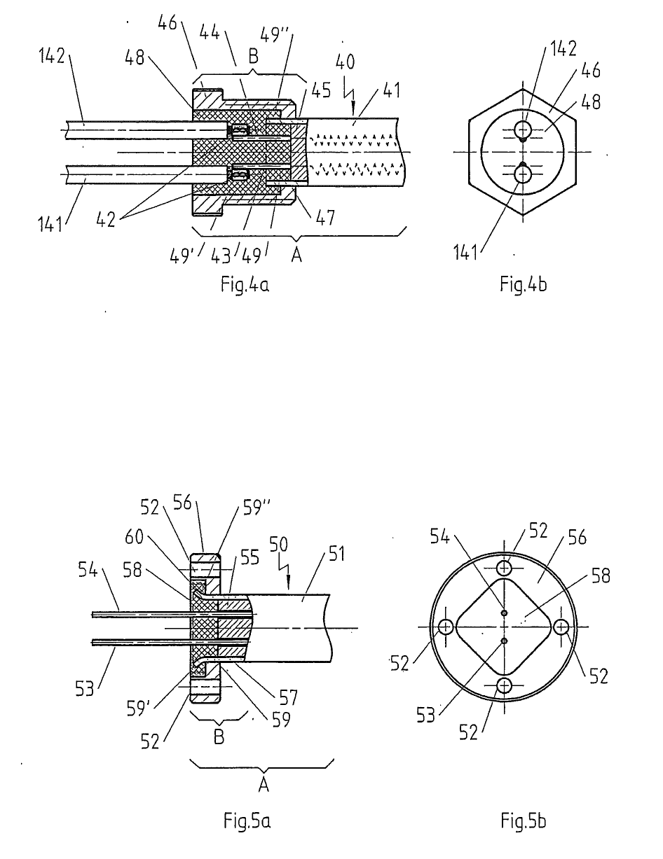

FIG. 4a shows a view of the end area A of a fourth exemplary embodiment of an electrical heating element 40 according to the present invention, wherein the end-side section B of the end area A of the electrical heating element 40 is shown cut open. A (not shown) section of the electrical heating element 40 continues this to the right as in the view shown in FIG. 1a.

One recognizes a metal jacket 41 and electrical connections 43 and 44. The metal jacket 41 is usually embodied as in the above-described first exemplary embodiment. The electrical connections 43 and 44 are embedded within the metal jacket 41 in a medium 45 at least in some sections, possible details of this embedding were already described based on the first exemplary embodiment.

The end section of the metal jacket 41 has on the end side a cavity 49, which is not filled with the medium 45.

Further, a connecting element 46 is shown, which lies on the metal jacket 41 with a section 47 and has a cavity 49′, which passes over into the cavity 49. The electrical connections 43 and 44 each pass over into this cavity in a contact element 42. The contact elements 42 make the contact with supply lines 141, 142 for the electrical connections 43, 44, which are provided in the cavity 49′ of the connecting element 46 from the connection-side direction.

A separating line between the cavities 49 and 49′ is shown dashed in FIG. 4a for illustration. Aside from the volume occupied by the passed-through connections 43, 44, the contact elements 42 and the supply lines 141, 142, the cavities 49 and 49′ are completely cast with pourable sealing compound 48, as a result of which a rigid, especially firm connection between the connecting element 46 and the metal jacket 41 is brought about. At the same time, it is consequently achieved that the electrical connection between the supply lines 141, 142 and the connections 43, 44 is fixed via the contact elements 42, and that the sealing against penetration of moisture is improved.

Further, the cavity 49′ has a partial area 49″, which is defined by an outer jacket surface of the metal jacket 41 and is likewise cast with pourable sealing compound 48. This enlarges the surface, on which a contact between pourable sealing compound 48 and metal jacket 41 is present, which brings with it a stronger mechanical hold.

FIG. 4b shows a front view of the connecting element 46 of the exemplary embodiment of FIG. 4a. One recognizes the pourable sealing compound 48 as well as the supply lines 141, 142 passed through it.

The connecting elements 16, 26, 36 and 46 of the four above-described embodiments according to FIGS. 1a through 4b advantageously have an external thread, with which the electrical heating element can be fixed in a corresponding counterthread arranged at a device.

FIG. 5a shows a view of the end area A of a fifth exemplary embodiment of an electrical heating element 50 according to the present invention, wherein the end-side section B of the end area A of the electrical heating element 50 is shown cut open. A (not shown) section of the electrical heating element 50 continues this to the right as in the view shown in FIG. 1a.

One recognizes a metal jacket 51 and electrical connections 53 and 54. The metal jacket 51 is usually embodied as in the above-described first exemplary embodiment. The electrical connections 53 and 54 are embedded within the metal jacket 51 in a medium 55 at least in some sections, possible details of this embedding were already described based on the first exemplary embodiment.

The end section of the metal jacket 51, which shows a circumferential bulging out 60 at its end, has on the end side a cavity 59, which is not filled with the medium 55.

Further, a connecting element 56 is shown, which lies on the metal jacket 51 with a section 57 and has a cavity 59′, wherein said cavity 59′ passes over into the cavity 59. The electrical connections 53 and 54 are passed through this cavity. A separating line between the cavities 59 and 59′ is shown dashed in FIG. 5a for illustration. Aside from the volume occupied by the electrical connections 53, 54 passed through, the cavities 59 and 59′ are cast with pourable sealing compound 58, as a result of which a rigid, especially firm connection is brought about between the connecting element 56 and the metal jacket 51.

Further, the connecting element 56 has mounting holes 52, which pass through it in a section overhanging the metal jacket 51 in the extension direction of the connections 53, 54. By means of these mounting holes 52, a fixing of the electrical heating device to a device by means of screws or pins is possible.

FIG. 5b shows a front view of the connecting element 56 of the exemplary embodiment of FIG. 5a. One recognizes the pourable sealing compound 58 as well as the connections 53, 54 passed through it and the mounting holes 52.

Further, the cavity 59′ has a partial area 59″, which is defined by an outer jacket surface of the metal jacket 51 and is likewise cast with pourable sealing compound 58. This enlarges the surface, on which a contact is present between pourable sealing compound 58 and metal jacket 51, which brings with it a stronger mechanical hold.

Moreover, one also recognizes in FIG. 5b the presence of a second component of a means for securing against rotation besides the not rotationally symmetrical arrangement of the electrical connections 53, 54. The connecting element has a section in the form of a square with rounded angles, which is filled with the pourable sealing compound 58. Thus, a structuring of a section of the connecting element 56 that is at least partly not rotationally symmetrical to the central axis of the heating element 50 is present, which is in contact with the pourable sealing compound 58 and thus provides torsional strength.

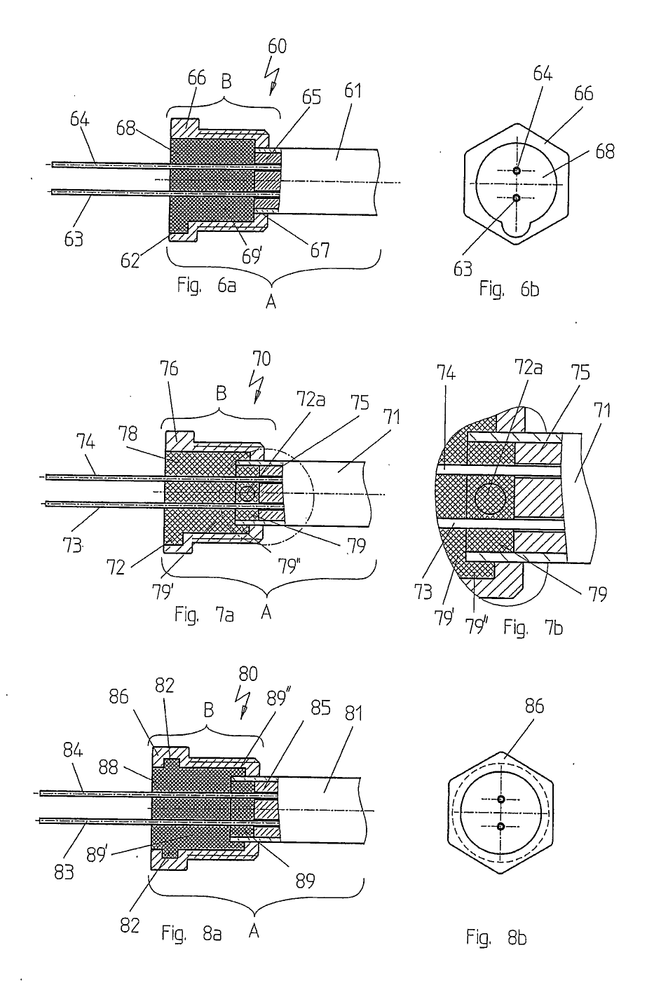

The embodiment, which is shown in FIGS. 6a and 6b, corresponds almost completely to the embodiment of FIGS. 2a and 2b, to whose description reference is made. The difference lies in that in this embodiment the area surrounded by the metal jacket 61 does not have a cavity and that the cavity 69′ of the connecting element 66 does not have a partial area that is defined by an outer jacket surface of the metal jacket 61. The mechanical connection between connecting element 66 and the electrical heating element with metal jacket is made here only by the interaction of the pourable sealing compound 68 with the front surfaces of the metal jacket and with the connections 63, 64. It turned out that the interaction with front surfaces of the metal jacket 61 is also not absolutely necessary to guarantee a stable connection.

The embodiment that is shown in FIGS. 7a and 7b corresponds almost completely to the embodiment of FIGS. 2a and 2b, to whose description reference is made. The difference is that in this embodiment the end section of the metal jacket 71 in the area, in which the metal jacket 71 surrounds the cavity 79, has a hole 72a. The provision of this hole 72a improves the mechanical connection between connecting element 76 and the electrical heating element with metal jacket 71 especially in terms of its tensile strength and torsional strength, since a structuring of a section of the metal jacket that is not rotationally symmetrical to the central axis of the heating element is thus present, with which the pourable sealing compound 78 meshes, so that a means for securing against rotation is formed.

The embodiment, which is shown in FIGS. 8a and 8b, corresponds almost completely to the embodiment of FIGS. 2a and 2b, to whose description reference is made. The difference is that in this embodiment, instead of the recess 22, a score 82 is provided in the connecting element 86, which is likewise cast with pourable sealing compound 88. The provision and casting of this score 82 improves the mechanical connection between connecting element 86 and the electrical heating element with metal jacket 81 likewise especially in terms of its tensile strength.

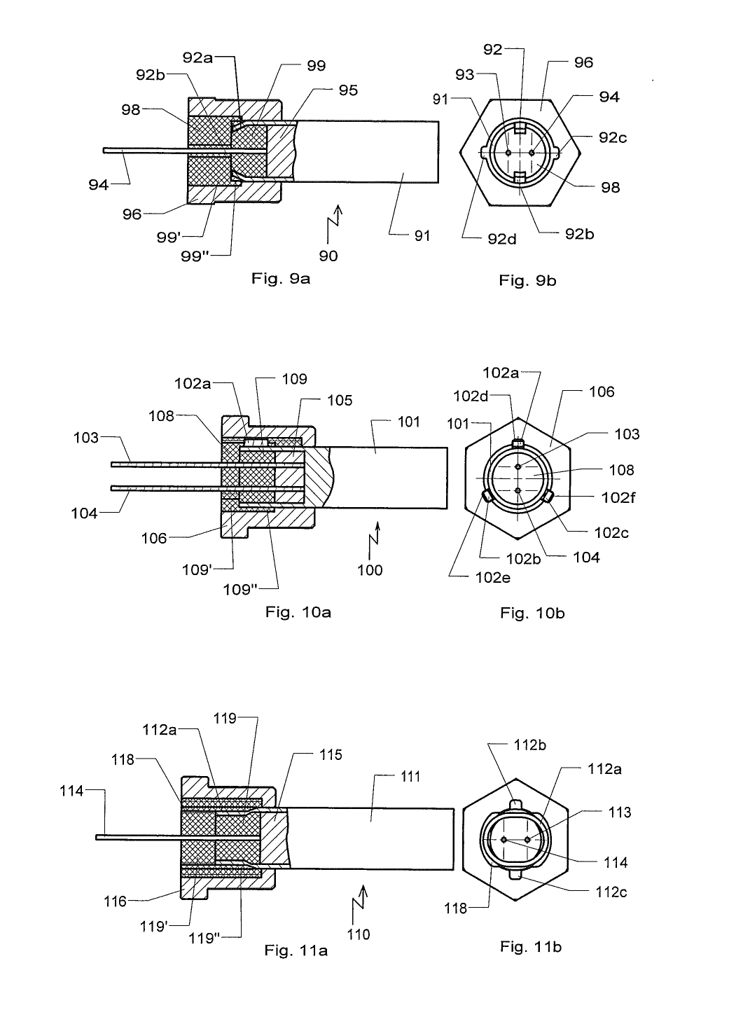

The embodiment, which is shown in FIGS. 9a and 9b, corresponds almost completely to the embodiment of FIGS. 1a and 1b, to whose description reference is made. The first essential difference between the embodiments is that two notches 92a, 92b are provided, which represent a structuring of a section of the metal jacket 91 that is not rotationally symmetrical to the central axis of the heating element 90, which likewise permits a full rotation of the pourable sealing compound 98 in relation to the metal jacket only by deforming or separating the notches 92a, 92b or splitting the pourable sealing compound 98 and thus leads to increased torsional strength.

The second essential difference between the embodiments, which can only be clearly recognized in FIG. 9b, is that the cavity 99 provided in the connecting element 96 has two bulges 92c, 92d, with which the pourable sealing compound 98 meshes.

Thus, a structuring of a section of the connecting element 96 that is not rotationally symmetrical to the central axis of the heating element 90 is also present, which interacts with the pourable sealing compound 98. Thus, a full rotation of the pourable sealing compound 98 in relation to the connecting element 96 is made possible only by deforming the bulges 92c, 92d or splitting the pourable sealing compound 98 and thus brings about increased torsional strength. Thus, a rotation of the pourable sealing compound 98 in relation to the connecting element 96 is not possible in this embodiment even when higher torques act on the connecting element 96.

Even higher torsional strength is achieved in the embodiment, which is shown in FIGS. 10a and 10b. This embodiment also corresponds almost completely to the embodiment of FIGS. 1a and 1b, to whose description reference is made. The first essential difference between the embodiments is that, instead of a notch, three local reinforcements 102a, 102b, 102c, which are embodied as square by way of example, are provided here at the end section of the metal jacket 101, which represent a structuring of a section of the metal jacket 101 that is not rotationally symmetrical to the central axis of the heating element 100.

The second essential difference between the embodiments, which can only be recognized clearly in FIG. 10b, is that the cavity 109 provided in the connecting element 106 has three bulges 102d, 102e, 102f, in which are mounted the reinforcements 102a, 102b, 102c. Optionally, provisions may also be made for the mounting to take place in an accurately matching manner, but it is preferable that pourable sealing compound 108 is also present in each of the bulges 102d, 102e, 102f, which fills especially a space between the reinforcements 102a, 102b, 102c and the respective wall of the bulges 102d, 102e, 102f.

Thus, a structuring of a section of the connecting element 106 that is not rotationally symmetrical to the central axis of the heating element 100 is also present, which interacts with the pourable sealing compound 108. Thus, a relative rotation of the components to one another is not possible in this embodiment even when applying very high torques.

The embodiment, which is shown in FIGS. 11a and 11b, corresponds almost completely to the embodiment of FIGS. 1a and 1b, to whose description reference is made. The first essential difference between the embodiments is that, instead of a notch, an oval deformation 112a of the end section of the metal jacket 111 is provided here, which represents a structuring of a section of the metal jacket 111 that is not rotationally symmetrical to the central axis of the heating element 110.

The second essential difference between the embodiments, which can only be clearly recognized in FIG. 11b, is that the cavity 119 provided in the connecting element 116 has an approximately oval shape and in addition two bulges 112b, 112c. Thus, a structuring of a section of the connecting element 116 that is not rotationally symmetrical to the central axis of the heating element 110 is also present, which interacts with the pourable sealing compound 118, and because of the oval shape, a rotation of the individual components is reliably prevented even when applying very high torques.

As is clearly evident from the above-described exemplary embodiments, the number and shape of structures that are provided at the end section of the metal jacket and/or in the connecting element may especially be varied. Of course, for example, the embodiment according to FIGS. 10a and 10b can also be embodied with only one reinforcement and one recess, and likewise, of course, notches may be provided directed radially outwards or reinforcements may be provided on the inside of the metal jacket.

While specific embodiments of the invention have been shown and described in detail to illustrate the application of the principles of the invention, it will be understood that the invention may be embodied otherwise without departing from such principles.

List of Reference Numbers

| A | End area |
|---|---|
| B | End-side section of the end |
| | area |
| 10, 20, 30, 40, 50, 60, 70, 80, 90, 100, 110 | Electrical heating element |
| 11, 21, 31, 41, 51, 61, 71, 81, 91, 101, 111 | Metal jacket |
| 13, 14, 23, 24, 33, 34, 43, 44, 53, 54, 63, 64, | Electrical connection |
| 73, 74, 83, 84, 93, 94, 103, 104, 113, 114 | |
| 15, 25, 35, 45, 55, 65, 75, 87, 95, 105, 115 | Medium |
| 16, 26, 36, 46, 56, 66, 76, 86, 96, 106, 116 | Connecting element |
| 17, 27, 37, 47, 57, 67, 77, 87, 97, 107, 117 | Section of the connecting |
| | element |
| 18, 28, 38, 48, 58, 68, 78, 88, 98, 108, 118 | Pourable sealing compound |
| 19, 19′, 19″, 29, 29′, 29″, 39, 39′, 39″, 39′″, | Cavity |
| 49, 49′, 49″, 59, 59, 59″, 69′, 79, 79′, 79″, | |
| 89, 89′, 89″, 99, 99′, 99″, 109, 109′, 109″, | |
| 119, 119′, 119″ | |
| 12, 92a, 92b | Notch |
| 22, 102d, 102e, 102f, 112b, 112c | Bulge |
| 32, 62 | Bulging out |
| 102a, 102b, 102c | Reinforcements |
| 112a | Oval deformation |
| 42 | Contact element |
| 52 | Mounting hole |
| 72a | Hole |
| 82 | Score |
| 141, 142 | Supply line |

What is claimed is:

1. An electrical heating element, comprising:
a metal jacket;
a connecting element in contact with at least a portion of said metal jacket;
an electrical connection, said connecting element having at least one cavity, at least a portion of said at least one cavity being adjacent to one or more of at least one section of said metal jacket and a portion of said electrical connection;
a pourable sealing compound; and
a means for securing at least said connection element against rotation, said at least one cavity being cast at least partly with said pourable sealing compound such that a direct, supporting mechanical connection is produced between one or more of said metal jacket and said connecting element and between said portion of the electrical connection and the connecting element by said pourable sealing compound, wherein the pourable sealing compound is in contact with said means for securing against rotation, said pourable sealing compound comprising at least one of a ceramic cement, epoxy resin and plastics.

2. An electrical heating element in accordance with claim 1, wherein said means for securing against rotation comprises at least a structuring of a section of the metal jacket which is not rotationally symmetrical to a central axis of the heating element.

3. An electrical heating element in accordance with claim 1, wherein said means for securing against rotation comprises at least a structuring of a section of said connecting element which is not rotationally symmetrical to a central axis of the heating element when said connecting element is positioned on the heating element.

4. An electrical heating element in accordance with claim 1, wherein said means for securing against rotation comprises said electrical connection not being rotationally symmetrical to a central axis of the heating element.

5. An electrical heating element in accordance with claim 1, wherein a partial area of said at least one cavity is defined by an outer jacket surface of said metal jacket.

6. An electrical heating element in accordance with claim 1, wherein an end-side section of said metal jacket comprises at least one metal jacket cavity, said at least one metal jacket cavity being arranged within said metal jacket, said at least one metal jacket cavity passing over into said at least one cavity of said connecting element, at least a portion of said at least one metal jacket cavity being cast with said pourable sealing compound.

7. An electrical heating element in accordance with claim 1, wherein said connecting element is made of plastic.

8. An electrical heating element in accordance with claim 1, wherein one or more of said connecting element and said metal jacket has, at one end section, a contour shape and one of an undercut, a notch, a bulging out portion, a knurling, a hole and a score.

9. An electrical heating element in accordance with claim 1, wherein said connecting element has one of an external thread and mounting holes.

10. An electrical heating element in accordance with claim 1, wherein said electrical connection has a contact element on an end side thereof, which is in electrical connection to supply lines, at least a portion of at least one of said supply lines being incorporated in said contact, said contact element and said at least said portion of said supply line incorporated in said contact element being embedded in said pourable sealing compound.

11. A process for manufacturing an electrical heating element, the process comprising the steps of:
providing an electrical heating element with a metal jacket and at least one electrical connection;
providing a connecting element comprising at least one cavity, one or more of said electrical heating element and said connecting element comprising a securing means for securing one or more of said electrical heating element and said connecting element against rotation;
providing a pourable sealing compound comprising at least one of a ceramic cement, an epoxy resin and plastic;
arranging said connecting element on a section of the metal jacket such that at least a portion of said at least one cavity is adjacent to one or more of a section of said metal jacket and a section of said electrical connection, wherein at least a portion of said connecting element is arranged on at least a portion of said metal jacket; and
at least partially casting said at least one cavity with said pourable sealing compound such that said pourable sealing compound is in contact with said securing means and such that said pourable sealing compound produces one or more of a direct, supporting mechanical connection between said metal jacket and said connecting element and a direct, supporting mechanical connection between said section of the electrical connection and the connecting element.

12. A process in accordance with claim 11, wherein said connecting element is arranged on the section of the metal jacket such that a partial area of said at least one cavity is defined by an outer jacket surface of said metal jacket.

13. A process in accordance with claim 11, wherein at least one metal jacket cavity is provided in said metal jacket on an end-side section of the metal jacket, said connecting element being arranged such that said at least one metal jacket cavity passes over into the at least one cavity of the connecting element, said at least partial casting taking place such that said at least one metal jacket cavity and said at least one cavity are at least partly cast with said pourable sealing compound.

14. A process in accordance with claim 11, wherein a contour shape is provided in one or more of said connecting element and said metal jacket at an end section thereof, said contour shape being defined by one of an undercut, a notch, a bulging out, a knurling, a hole, and a score.

15. A process in accordance with claim 14, wherein said contour shape is provided after arranging said connecting element at said metal jacket of said electrical heating element and before casting with said pourable sealing compound.

16. A process in accordance with claim 11, wherein said at least one electrical connection has a contact element on an end side thereof, said contact element being brought into electrical connection to a supply line before said casting, at least a section of said supply line being incorporated into said contact element, said contact element and said at least said section of said supply line incorporated into said contact element being embedded into said pourable sealing compound during said casting.

17. An electrical heating element, comprising
a metal jacket;
a connecting element engaging at least a portion of said metal jacket;
a pourable sealing compound;
an electrical connection, said connecting element having at least one cavity, at least a portion of said metal jacket defining at least a portion of said least one cavity, at least a portion of said electrical connection extending through said at least one cavity, one or more of said metal jacket and said connecting element comprising a securing means for securing at least said connecting element against rotation, said at least one cavity being at least partially filled with said pourable sealing compound such that said pourable sealing compound engages said least one portion of said metal jacket, securing means and said connecting element, said connecting element being connected to one or more of said metal jacket and said electrical connection via said pourable sealing compound.

18. An electrical heating element in accordance with claim 17, wherein said pourable sealing compound comprises at least one of a ceramic cement, epoxy resin and plastics, said pourable sealing compound being in contact with at least a portion of said electrical connection.

19. An electrical heating element in accordance with claim 17, wherein said securing means comprises at least a section of the metal jacket that is not rotationally symmetrical to a central axis of the heating element, wherein a partial area of said at least one cavity is defined by an outer jacket surface of said metal jacket.

20. An electrical heating element in accordance with claim 17, wherein an end-side section of said metal jacket comprises at least one metal jacket cavity, said at least one metal jacket cavity being defined within said metal jacket, said at least one metal jacket cavity being in communication with said at least one cavity of said connecting element, at least a portion of said at least one metal jacket cavity being filled with said pourable sealing compound, at least another portion of said at least one metal jacket cavity being filled with a medium, said medium being in contact with said pourable sealing compound, wherein one or more of said connecting element and said metal jacket has, at one end section, a contour shape, said contour shape being defined by one of an undercut, a notch, a bulging out portion, a knurling, a hole and a score.
